(19) United States
(12) Patent Application Publication
(10) Pub. No.: US 2012/0163810 A1
(43) Pub. Date: Jun. 28, 2012

(54) OPTICAL DEVICE, OPTICAL TRANSCEIVER UNIT, AND OPTICAL COMMUNICATION SYSTEM

(75) Inventor: Miki ONAKA, Kawasaki (JP)

(73) Assignee: Fujitsu Limited, Kawasaki-shi (JP)

(21) Appl. No.: 13/329,886

(22) Filed: Dec. 19, 2011

(30) Foreign Application Priority Data
Dec. 27, 2010 (JP) 2010-289453

(51) Int. Cl. G02F 1/01; H04J 14/02; H04B 10/08

(52) U.S. Cl. 398/38; 398/25; 398/79; 359/288

(57) ABSTRACT

An optical device includes an optical element that is secured to a base material, a temperature variable element the temperature of which is variable, the temperature variable element being secured to the base material such that light propagates between the temperature variable element and the optical element, a housing that houses the optical element and the temperature variable element, and a heat conducting medium that is disposed at a position that is different from a position of the base material and away from an optical path through which the light propagates, the heat conducting medium physically contacting the optical element and the temperature variable element.

### CROSS-REFERENCE TO RELATED APPLICATIONS

This application is based upon and claims the benefit of priority of the prior Japanese Patent Application No. 2010-289453, filed on Dec. 27, 2010, the entire contents of which are incorporated herein by reference.

### FIELD

Embodiments of the present invention relate to an optical device including a housing that houses an optical element and a temperature variable element. Embodiments of the present invention also relate to an optical transceiver and an optical communication system that use the optical device.

### BACKGROUND

Nowadays, the demand for communication traffic is significantly increasing due to trends such as increasing use of the Internet and the like. In order to meet the demand, optical fiber transmission technology that performs communication by transmitting optical signals through a single optical fiber has been established for current high-capacity transmission. As photonic network systems that extend the limits of backbone long-distance high-capacity systems, more flexible and more economical transport networks are being built so as to realize photonic networks for a high-capacity information society. It is conceivable that such optical communication systems are routed not only to backbone systems and metropolitan area networks, but also routed to the vicinities of offices and homes. Thus, it is desirable that the optical communication systems be more reliably realized at lower costs and have more advanced capabilities and diversity. To meet these needs, the optical communication systems desirably use optical devices having a variety of compensation functions so as to perform advanced control of transmission quality.

Based on the structures, the above-described optical devices may be generally classified into fiber optical devices, waveguide optical devices, and space-coupling optical devices (lens optical devices). In a fiber optical device, one or several optical fibers are processed in order to add a desired function (for example, a function of a fiber grating, a fused optical fiber coupler, or the like). This optical device is highly manufacturable, small in size, and fabricated at a low cost. In a waveguide optical device, optical waveguides are formed in an optical substrate in order to fabricate an interferometer, a diffraction grating, or the like, thereby adding a desired function. This structure is suitable for enlarging a multi-channel or array structure.

In a space-coupling optical device (lens), an optical film (for example, dielectric multi-layer film), crystals, or the like are disposed in a spatial optical system using micro-lenses, thereby controlling light beams so as to add a desired function. The space-coupling optical device has an assembly structure in which a plurality of elements of the spatial optical system are separately arranged in specified positions. Thus, advanced functions may be easily realized at a low cost. For this reason, the space-coupling optical devices are widely used in optical communication systems. Specific examples of the space-coupling optical devices include a tunable dispersion compensator, polarization mode dispersion compensator, an optical switch, an optical circulator, an optical isolator, a tunable optical attenuator, an optical filter, an optical power monitoring module, and a light source module (for example, see Japanese Unexamined Patent Application Publication No. 2003-279896). The elements of the spatial optical system are typically housed in a housing (for example, see Japanese Unexamined Patent Application Publication No. 2005-136384). The elements of the spatial optical system are secured to a base material (For example, see Japanese Unexamined Patent Application Publication No. 2008-177401).

However, the related art space-coupling optical device as described above has a problem in that foreign matter adheres to the elements inside the housing. This phenomenon is associated with the structure. When foreign matter adheres to the elements of the spatial optical system and obstructs a traveling path of the light beam, the insertion loss of the space-coupling optical device increases. An increase in the insertion loss causes optical transmission characteristics such as the optical signal-to-noise (S/N) ratio to be degraded. When the degree of adhesion of foreign matter on the optical path of the spatial optical system increases, transmission of an optical signal is not ensured.

This adhesion of foreign matter will be described in detail as follows. That is, when air-tightness of the housing of the space-coupling optical device is maintained to a certain degree even using simple sealing, a possibility of some external foreign matter entering into the housing is small. However, a slight amount of an organic substance and moisture included in the atmosphere of the housing may be deposited inside the housing over a certain time and the deposited substance is accumulated as foreign matter in a specific position. For example, it is conceivable that, when a slight amount of a hydro-carbon inside the housing undergoes a polymerization reaction due to a photochemical reaction, the product material (an organic substance) adheres to the elements inside the housing. Examples of hydrocarbons inside the housing include an organic solvent used to clean the elements in a fabricating process of a space-coupling optical device and flux used in soldering. Such hydrocarbons may cause the adhesion of foreign matter as described above even when the amount remaining in the housing is very small (for example, in the order of parts per million (ppm)). Components of an adhesive (for example, epoxy resin and the like) that is generally used to secure the elements or simply seal the devices may be scattered in the atmosphere inside the housing over the years and cause the adhesion of foreign matter as described above.

That is, it is very difficult to perform a fabrication process of the space-coupling optical device under conditions in which causative substances of adhesion of foreign matter do not exist in the housing. Even when the atmosphere in the housing is successfully maintained free of a causative substance, it is difficult to prevent the following situation from occurring. That is, a slight amount of organic substances, which scatter over the years from the adhesive or the like used to secure the elements or for other purposes, from being deposited on surfaces of the elements such as lenses. Since it is known that an adhesive passes moisture therethrough, when an adhesive is used for simple air-tight sealing of the housing, it is possible that moisture enters the housing from an area outside the housing through the adhesive and assists adhesion of foreign matter. Although entering of external moisture may be prevented by perfectly air-tight sealing of the housing using laser welding or the like, this causes the cost of the optical device to increase. Furthermore, this is not a means for avoiding a situation in which a slight amount of substances inside the housing form foreign matter over the years.

Adhesion of foreign matter in the space-coupling optical device as described above markedly occurs when there are a plurality of elements in the housing and the temperature of at least one of the elements is controlled to increase. FIGS. 1A to 1C illustrate an example of a mechanism in which the adhesion of foreign matter occurs. Here, a space-coupling optical device 100 is assumed to have the following example structure. That is, three elements 121, 122, and 123 are secured onto a base material 120 disposed inside a housing 111, and light having entered the housing 111 through an input optical fiber 112 sequentially passes through the elements 121 to 123 and is output to an output optical fiber 113. A shaded area A in the drawings indicates a path of the light beam that propagates through an inner space of the housing 111. The elements 121 and 123 respectively disposed on the input and output sides, are, for example, lenses. The central element 122 is one of a variety of optical devices the temperatures of which are controlled to increase to temperatures that are higher than the ambient temperature during an operation of the space-coupling optical device 100 so as to control the light beam, and accordingly, to realize a desired function.

Referring to FIG. 1A, when the space-coupling optical device 100 is not operated, the temperature inside the housing 111 is substantially constant at the ambient temperature Ta. Referring to FIG. 1B, when the optical device 100 is operated, the temperature of the element 122 is controlled to increase and thereby generating a temperature gradient inside the housing 111. The temperatures near the other elements 121 and 123 (lenses) become lower relative to the temperature near the element 122 (a graph in FIG. 1B). At this time, for example, when a causative substance B such as an adhesive exists between the elements 121 and 122, a temperature rise inside the housing 111 causes an organic substance included in the adhesive or the like to evaporate and scatter inside the housing 111 (a diagram in FIG. 1B). The organic substance is, for example, a hydrocarbon. The organic substance produces a substance when the substance, for example, undergoes a photochemical reaction due to the light beam that propagates between the elements. The resultant product is deposited as foreign matter C on surfaces of the elements 121 and 123, the temperatures of which are relatively low (FIG. 1C). Moisture having evaporated near the high-temperature element 122 also assists adhesion of foreign matter to the low-temperature elements 121 and 123. When adhesion of the foreign matter C occurs at a position on the optical path A, the insertion loss increases. The foreign matter C, which adheres to the low-temperature elements 121 and 123, is accumulated as operating time of the space-coupling optical device 100 elapses, thereby causing a progressive problem. A mechanism in which a substance evaporates on the high temperature side, and condensation and adhesion of foreign matter occurs on a low temperature side is a physical phenomenon that may be explained using a saturated vapor curve.

In order to detect a problem caused by adhesion of foreign matter as described above, measures such as a screening inspection before an optical device is shipped as a product are presently taken. However, since such a screening inspection generally includes a complex process while decreasing a yield of the optical device, the cost of the optical device increases.

In addition to an increase in the insertion loss due to adhesion of foreign matter, a shift of the optical path may occur in the optical device of the spatial optical system due to a change in the ambient temperature.

### SUMMARY

According to an aspect of the disclosed embodiments, an optical device includes an optical element that is secured to a base material, a temperature variable element the temperature of which is variable, the temperature variable element being secured to the base material such that light propagates between the temperature variable element and the optical element, a housing that houses the optical element and the temperature variable element, and a heat conducting medium that is disposed at a position that is different from a position of the base material and away from an optical path through which the light propagates, the heat conducting medium physically contacting the optical element and the temperature variable element.

The object and advantages of the disclosed embodiments will be realized and attained by means of the elements and combinations particularly pointed out in the claims.

It is to be understood that both the foregoing general description and the following detailed description are exemplary and explanatory and are not restrictive of the disclosed embodiments, as claimed.

### BRIEF DESCRIPTION OF DRAWINGS

FIGS. 1A to 1C illustrate an example of a mechanism in which adhesion of foreign matter occurs in a related-art space-coupling optical device;

FIG. 2 is a perspective view illustrating the structure of a main portion of an optical device according to an embodiment of the present invention;

FIGS. 3A and 3B illustrate the structure of a heat conducting medium according to the embodiment;

FIGS. 4A and 4B illustrate an operation according to the embodiment;

FIG. 5 is a perspective view illustrating the structure of a portion of an optical device according to an alternative embodiment of the present invention;

FIG. 6 illustrates an example of a specific structure of an element (a lens) according to the alternative embodiment;

FIG. 7 illustrates an example of a specific structure of an element (a chromatic dispersion device) according to the alternative embodiment;

FIGS. 8A and 8B illustrate general structures of optical devices that use cylinder-shaped heat conducting media according to modifications of the embodiments;

FIGS. 9A and 9B illustrate the structure of the cylinder-shaped heat conducting medium;

FIGS. 10A and 10B illustrate general structures of optical devices that use plate-shaped heat conducting media according to modifications of the embodiments;

FIGS. 11A and 11B illustrate the structure of the plate-shaped heat conducting medium;

FIG. 12 is a block diagram illustrating the structure of an example of an application relating to the above-described embodiments to which a function of monitoring an increase in the insertion loss due to adhesion of foreign matter is added;

FIG. 13 is a block diagram illustrating an embodiment of an optical transceiver unit that uses the optical device illustrated in FIG. 12; and

FIG. 14 is a block diagram illustrating an embodiment of an optical communication system that is configured using the optical transceiver units illustrated in FIG. 13.

### DESCRIPTION OF EMBODIMENTS

Embodiments of the present invention will be described in detail below with reference to the accompanying drawings.

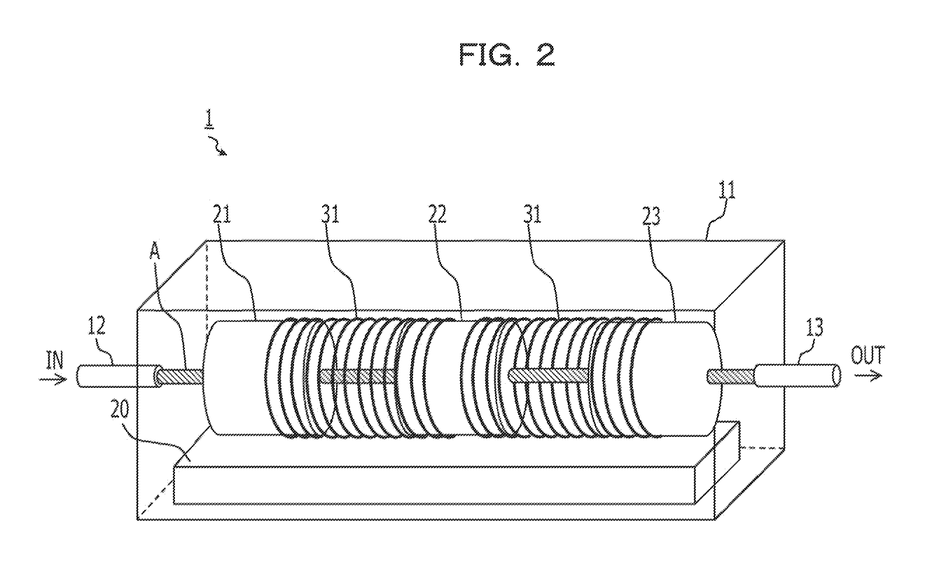

FIG. 2 is a perspective view illustrating the structure of a portion of an optical device according to an embodiment of the present invention. Referring to FIG. 2, an optical device 1 according to the present embodiment includes, for example, a housing 11, an input optical fiber 12, an output optical fiber 13, a base material 20, a plurality of elements 21, 22, and 23, and heat conducting media 31.

The housing 11 houses a spatial optical system that includes the plurality of elements 21 to 23. The plurality of elements 21 to 23 are spaced apart at desired intervals on the base material 20 disposed in the housing 11, and separately secured onto the base material 20 using an adhesive or the like. The input optical fiber 12 and the output optical fiber 13 are attached to the housing 11. Light having passed through the input optical fiber 12 enters the housing 11, sequentially passes through the elements 21 to 23, and is output through the output optical fiber 13, for example. When the spatial optical system is housed in the housing 11 while air-tightness of the housing 11 is maintained, the inside of the housing 11 is charged with a stable gas such as a nitrogen gas (N₂), for example. The elements 21 to 23 are secured onto the base material 20 using an adhesive or the like so as to prevent the optical path of the spatial optical system from shifting.

Each of the elements 21 to 23 controls a light beam that is incident thereupon. For example, assume that the space-coupling optical device 1 is a tunable dispersion compensator. The element 21 disposed on a light input side may be a lens that converts light emitted from an end of the input optical fiber 12 into parallel light or the like. The light beam having passed through the element 21 on the light input side enters the element 22. The element 22 may be a temperature variable element, the temperature of which is controlled to rise to a temperature that is higher than the ambient temperature during an operation. The temperature variable element gives a variable chromatic dispersion value to the incident beam. The temperature variable element may be a peltier element or a heater, for example. The element 23, which is disposed on a light output side, may be a lens that condenses the light beam having passed through the element 22 in order to connect the light beam to an end surface of the output optical fiber 13.

As described above, using a combination of light beam controls of the respective elements included in the spatial optical system, a desired function of the entire optical system may be realized. One of operational features of the spatial optical system is that the temperature of at least one of the elements is controlled to increase (or decrease) during an operation. It is conceivable that a function that may be realized with such a spatial optical system is not limited to the function of the above-described tunable dispersion compensator, but functions of a variety of optical devices including, for example, a polarization mode dispersion compensator, an optical switch, an optical circulator, an optical isolator, a variable optical attenuator, an optical filter, an optical power monitoring module, and a light source module may be realized. That is, the structure according to the present embodiment is effective for space-coupling optical devices having a variety of functions that may be each realized by suitably selecting and combining functions and the numbers of the elements included in the spatial optical system. In some of the above-described fiber optical devices and the waveguide optical devices, a space-coupling structure is partly used in order to realize a desired function. The structure according to the present embodiment is also effective for such an optical device to part of which space-coupling is applied.

The heat conducting media 31 are formed of a material having a heat conductivity that is greater than that of the base material 20. The heat conducting media 31 physically connect the adjacent elements of the elements 21 to 23 to each other in the spatial optical system. Each of the heat conducting media 31 has, for example, a helical structure, and the ends of the helical structure contacts the adjacent elements. By doing this, the heat conducting media 31 allow heat generated in the element 22, the temperature of which is controlled to increase during an operation, to be efficiently transferred to the low-temperature elements 21 and 23. The heat conducting media 31 and the elements 21 to 23 may be bonded to each other using an adhesive. However, since the adhesive may be a causative substance of foreign matter, the above-described connection method using contact is preferable. Alternatively, the heat conducting media 31 and the elements 21 to 23 may be made to have engaging structures so as to reliably connect to each other.

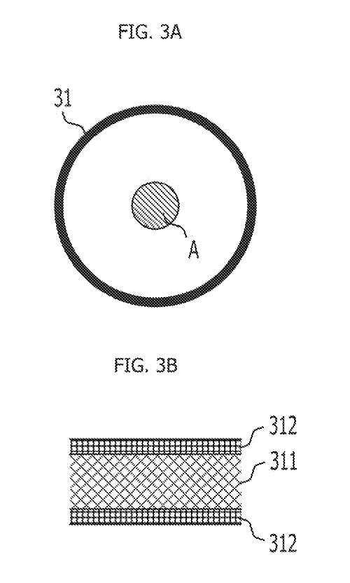

FIG. 3A is a plan view of the heat conducting medium 31 seen from the axial direction of an optical path A. FIG. 3B is an enlarged sectional view of the heat conducting medium 31 seen from a direction along the helix. As illustrated in FIG. 3A, the heat conducting medium 31 has a hollow portion that is formed inside the helical structure so as to pass the optical path A through the hollow portion. Thus, the heat conducting medium 31 is structured so as not to prevent the light beam from propagating between the elements 21 to 23. The heat conducting medium 31 preferably has a thin film layer 312 as illustrated in FIG. 3B, which serves as a gettering portion that absorbs organic substances and moisture, on a surface of a helical member 311. The thin film layer 312 is able to efficiently getter organic substances and moisture that are suspended in a space inside the housing 11 using a large surface area of the helical structure.

Preferably, the helical member 311 is formed of a metal material that has a heat conductivity that is greater than that of the base material 20, and that is not a causative substance of foreign matter (not an organic substance). Specifically, the material of the helical member 311 may be a metal material such as, for example, silver, copper, gold, aluminum, or duralumin. The helical member 311 is fabricated by forming the metal material into a helical shape.

The material of the thin film layer 312 (a getter substance) may be a material that includes, for example, calcium oxide (CaO), barium oxide (BaO), calcium carbonate (CaCO₃), phosphoric oxide (P₂O₅), zeolite, silica gel, or alumina. Alternatively, the material may include a substance selected from the group consisting of Groups 1, 4, 5, 6, 8, 9, 10, 11, 13, 15, 16, 17 and 18 classified in accordance with rules set forth by the International Union of Pure and Applied Chemistry (IUPAC). The thin film layer 312 is fabricated by forming a thin film including a getter substance as described above on the surface of the helical member 311 using a known deposition method or the like.

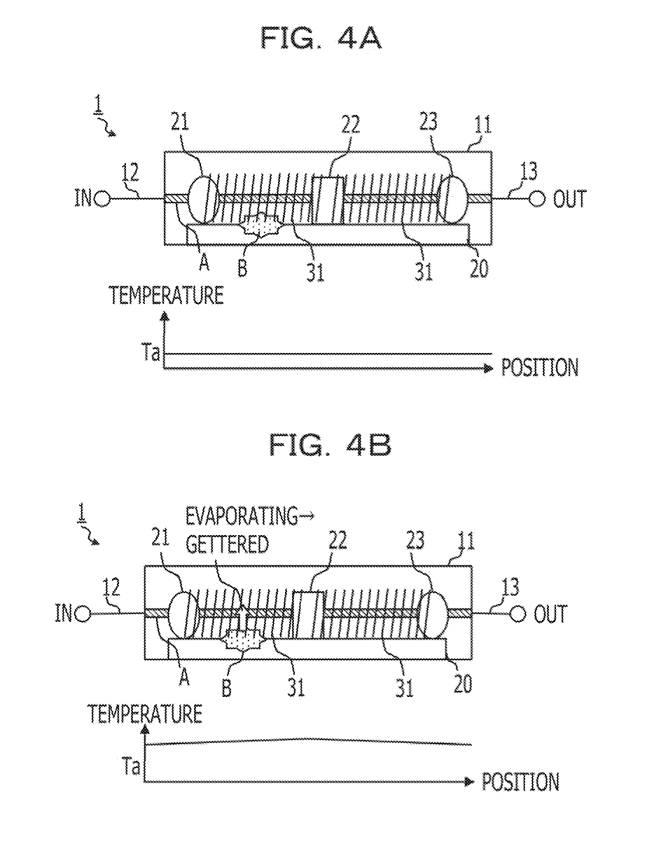

Next, operations of the optical device 1 having the above-described structure will be described with reference to FIGS. 4A and 4B.

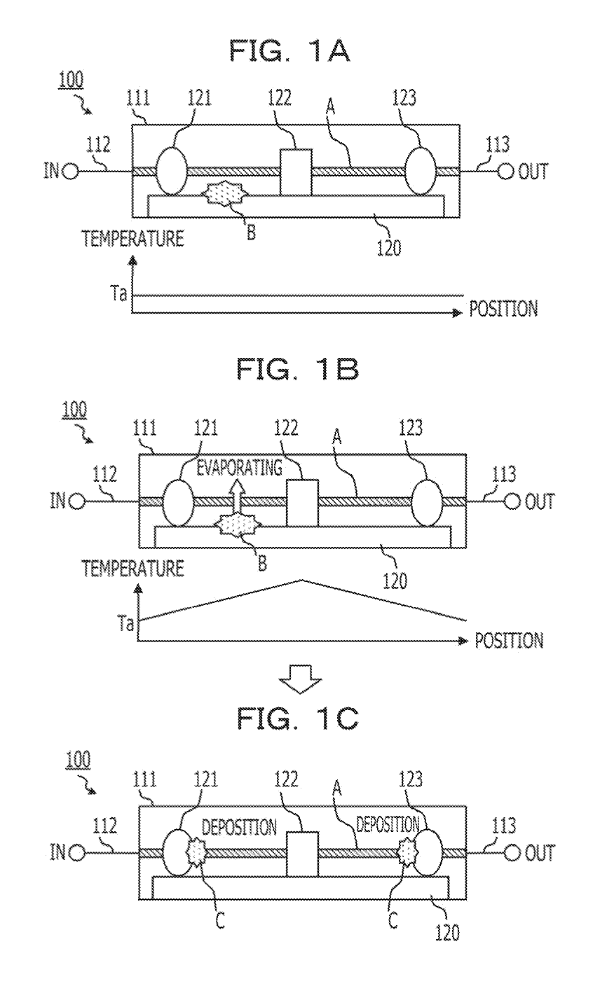

Referring to FIG. 4A, when the optical device 1 is not operated, the temperature inside the housing 11 is substantially constant at the ambient temperature Ta. This is similar to the state of the related art illustrated in FIG. 1A above. In contrast, referring to FIG. 4B, when the optical device is operated, the temperature of the element 22 is controlled to increase, thereby generating heat. The heat generated in the element 22 is transferred to the elements 21 and 23, the temperatures of which are not controlled, through the heat conducting media 31 having a heat conductivity greater than that of the housing 11. Thus, compared to the related art illustrated in FIG. 1A, the relative difference in temperature between the element 22, the temperature of which is controlled to increase, and the other elements 21 and 23 decreases, and accordingly, such a temperature gradient as that occurs inside the housing of the related-art is flattened.

When the temperature inside the entire housing 11 increases during the operation of the space-coupling optical device 1, a causative substance B of adhesion of foreign matter evaporates and scatters inside the housing 11. However, the evaporated causative substance B is gettered using the thin film layer 312 of each heat conducting medium 31. In particular, since the thin film layer 312 is formed utilizing a large surface area of the helical member 311, a large proportion of the evaporated causative substance B may be efficiently gettered.

The remaining causative substance B that has not been gettered freely moves in the housing 11. However, since the temperature difference between the elements 21 to 23 is decreased using the heat conducting media 31, there is almost no possibility that the causative substance B that reaches near the element 21 or 23, the temperatures of which are not controlled, is deposited on a surface of the element 21 or 23 as foreign matter. Since gettering using the thin film layer 312 efficiently removes not only evaporated organic substances (hydro carbons) but also moisture in the housing 11, there is almost no possibility that adhesion of foreign matter is assisted by moisture, which occurs in the related-art housing, either.

Thus, the optical device 1 according to the present embodiment realizes a structure of the spatial optical system housed inside the housing 11. With this structure, foreign matter does not easily adhere and accumulate on the surfaces of the elements 21 to 23 that are positioned on the optical path A. As a result, an increase in the insertion loss that would occur in the related-art optical device 1 may be reduced and/or avoided. Accordingly, there is less reason to perform a screening inspection before the optical device 1 is shipped as a product in order to reduce and/or prevent problems due to adhesion of foreign matter from occurring. Thus, the optical device 1 may be fabricated at a relatively low cost as compared with related-art device. Moisture inside the housing 11 is gettered using the thin film layer 312 according to an embodiment. This should produce effects that extend the life of the elements 21 to 23, for example. Furthermore, in an assembly process of the spatial optical system, locations of the elements 21 to 23 may be determined using the heat conducting media 31 as guides, which may facilitate assembly work.

Next, an optical device according to an alternative embodiment of the present invention will be described.

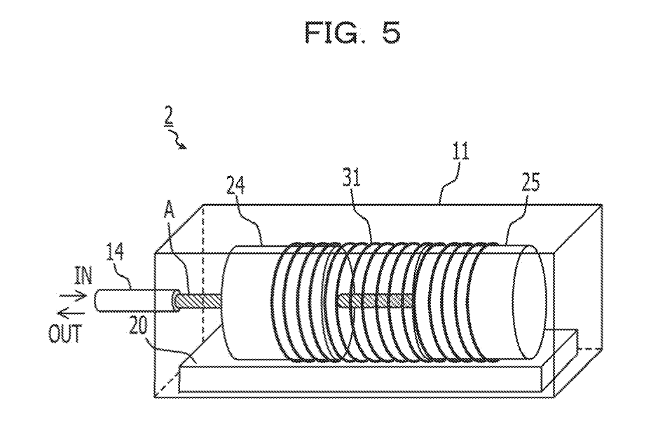

FIG. 5 is a perspective view illustrating the structure of a portion of an optical device according to an alternative embodiment. The optical device 1 illustrated in FIG. 2 has a transmissive structure, in which light having passed through the input optical fiber 12 enters the space inside the housing 11, sequentially passes through the elements 21 to 23, and is output to the output optical fiber 13. An optical device 2 illustrated in FIG. 5 has a reflective structure.

Specifically, in the optical device 2, for example, two elements 24 and 25 are spaced apart at a desired interval on the base material 20 disposed in the housing 11, which is similar to that of the optical device 1, and separately secured onto the base material 20 using an adhesive or the like. Light having passed through an input-output optical fiber 14 enters the inside of the housing 11, passes through the element 24, is reflected by the element 25, and is returned back to the element 24. The returned light is output to the input-output optical fiber 14.

Each of the elements 24 and 25 controls a light beam that is incident thereupon. For example, assume that the space-coupling optical device 2 is a tunable dispersion compensator similar to the above-described space-coupling optical device 1. The element 24 may be a lens that converts light output from an end of the input-output optical fiber 14 into parallel light or the like, and condenses the light reflected by the element 25 in order to connect the light to an end surface of the input-output optical fiber 14. The element 25 may be a temperature variable element, the temperature of which is controlled to rise to a temperature that is higher than the ambient temperature during an operation. The temperature variable element gives a variable chromatic dispersion value when the incident beam is reflected.

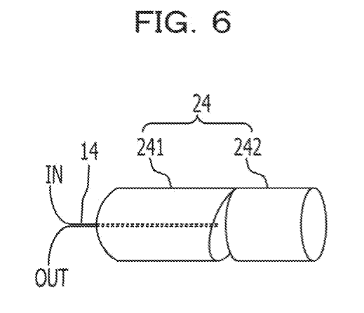

FIG. 6 illustrates an example of a specific structure of the element 24. In this example of the structure, the element 24 includes a capillary tube 241 and a G-lens 242. A tip portion of the input-output optical fiber 14, which is attached to the housing 11, is secured to the capillary tube 241. The G-lens 242 is disposed near an obliquely cut end surface of the capillary tube 241 and controls a light beam that is input from or output to the input-output optical fiber 14.

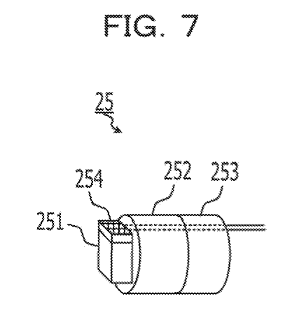

FIG. 7 illustrates an example of a specific structure of the element 25. In this example of the structure, the element 25 includes a chromatic dispersion device 251, a base material 252, a heater 253, and a thermistor 254. The chromatic dispersion device 251 may use an etalon or the like. Light having passed through the element 24 is incident upon the chromatic dispersion device 251, and the chromatic dispersion device 251 returns the reflected light, to which chromatic dispersion according to the temperature of the device is given, to the element 24. The base material 252 is formed of a material such as Si, for example. The chromatic dispersion device 251 and the thermistor 254 are mounted on the base material 252. The heater 253 causes the temperature of the chromatic dispersion device 251 to change through the base material 252. An operation of the heater 253 is controlled using a temperature control circuit (not shown) in accordance with the temperature of the chromatic dispersion device 251 measured using the thermistor 254 and a setting of the chromatic dispersion value.

The elements 24 and 25 are physically connected to each other using the heat conducting medium 31 similar to that used in the above-described optical device 1 (see FIG. 3A). The heat generated in the element 25, the temperature of which is controlled to increase during an operation, is efficiently transferred to the low-temperature element 24 through the heat conducting medium 31. Organic substances and moisture evaporated inside the housing 11 is gettered using the thin film layer 312 of the heat conducting medium 31.

Operations and effects similar to those performed and produced using the optical device 1, which has the above-described transmissive structure, may also be performed and produced using the optical device 2 having the reflective structure as described above.

The optical device 2 may use, for example, a light emitting element such as a semiconductor laser instead of the chromatic dispersion device 251 illustrated in FIG. 7 so as to condense light output from the light emitting element using the element 24 and connect the light to the end surface of the input-output optical fiber 14. That is, the structure of the spatial optical system as illustrated in FIG. 5 may also be adapted to a light source module.

In the above-described optical device 1 and the optical device 2 according to the respective embodiments, the heat conducting media 31 are used. Each of the heat conducting media 31 has a helical structure so as to physically connect the adjacent elements to each other. However, the heat conducting medium may have a shape other than a helical shape. Examples of modifications of the heat conducting medium will be described below.

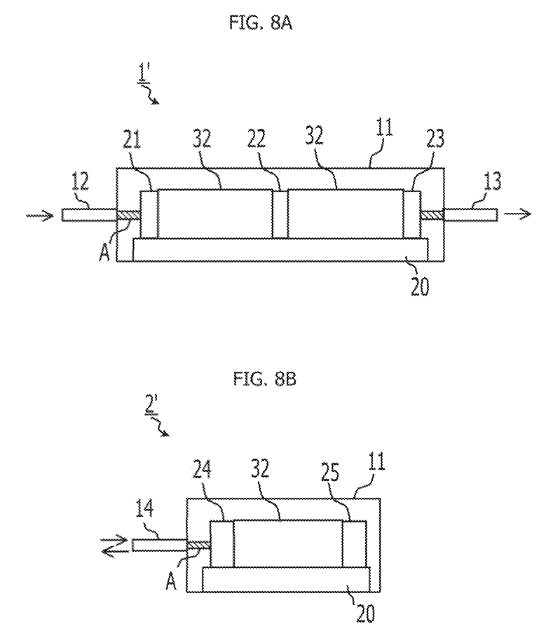

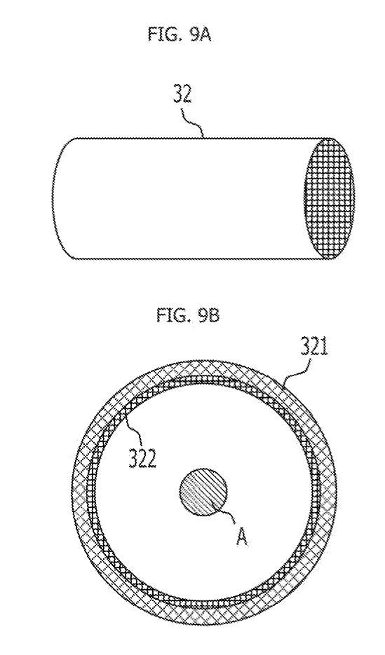

FIGS. 8A to 9B illustrate a modification of the heat conducting medium that has a cylindrical shape. FIG. 8A illustrates a general structure of an optical device 1′. In the optical device 1′, a cylinder-shaped heat conducting media 32 are applied to the above-described transmissive structure illustrated in FIG. 2. FIG. 8B illustrates a general structure of an optical device 2′. In the optical device 2′, the cylinder-shaped heat conducting medium 32 is applied to the above-described reflective structure illustrated in FIG. 5.

As illustrated in FIGS. 9A and 9B, the heat conducting medium 32 has a thin film layer 322 that is formed on an inner surface of a cylinder-shaped member 321. The cylinder-shaped member 321 has a heat conductivity that is greater than that of the base material 20. The thin film layer 322 getters organic substances and moisture. The thin film layer 322 may be formed on an outer surface of the cylinder-shaped member 321 in addition to the inner surface of the cylinder-shaped member 321. End portions of the heat conducting media 32 contact the adjacent elements of the elements 21 to 25 (see FIGS. 8A and 8B) so as to pass the optical path A through the hollow portions (see FIG. 9B) inside the cylinder.

In the optical device 1′ that uses the cylinder-shaped heat conducting media 32 as described above, heat generated in the element 22, the temperature of which is controlled to increase, is easily transferred to the other elements 21 and 23 compared to a case in which the helically structured heat conducting media 31 are used. This is also true with the optical device 2′, in which heat is generated in the element 25 and transferred to the other element 24. Thus, despite an increase in power consumption due to the heater and the like used to control the temperature of the element 22 or 25 to a desirable level, the difference in temperature between the elements housed in the same housing decreases. In addition, since it is ensured that the thin film layer 322 formed on the heat conducting medium 32 has a sufficient area, organic substances and moisture evaporated inside the housing 11 are efficiently gettered. Thus, in a circumstance in which an increase in power consumption is tolerable, an increase in the insertion loss due to adhesion of foreign matter is more reliably avoidable.

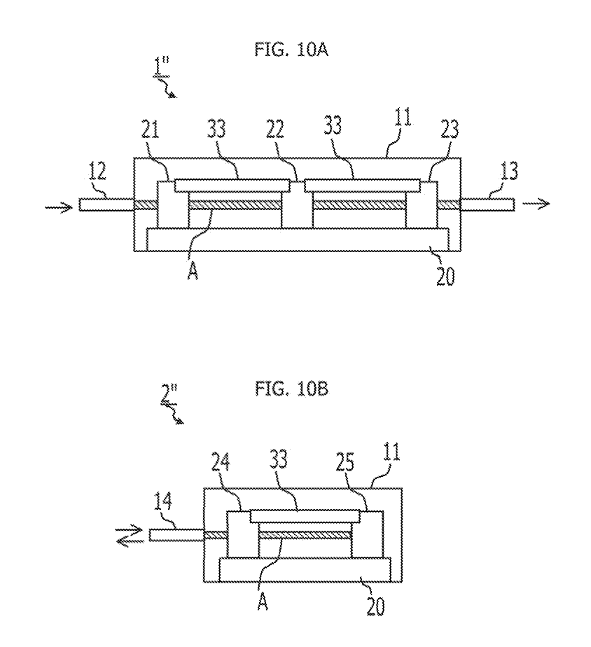

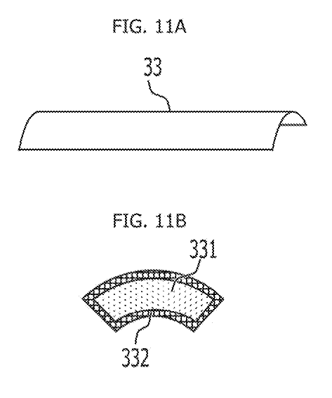

FIGS. 10A to 11B illustrate a modification of the heat conducting medium that has a plate-like shape. FIG. 10A illustrates a general structure of an optical device 1″. In the optical device 1″, plate-shaped heat conducting media 33 are applied to the above-described transmissive structure illustrated in FIG. 2. FIG. 10B illustrates a general structure of an optical device 2″. In the optical device 2″, the plate-shaped heat conducting medium 33 is applied to the above-described reflective structure illustrated in FIG. 5.

As illustrated in FIGS. 11A and 11B, the heat conducting medium 33 has a thin film layer 332 that is formed on front and rear surfaces of a plate-shaped member 331. The plate-shaped member 331 has a heat conductivity that is greater than that of the base material 20, and the thin film layer 332 getters organic substances and moisture. The section of the plate-shaped member 331 has a curved shape. This curve matches the shape of each of the elements 21 to 25. Longitudinal end portions of each of the heat conducting media 33 are secured to the adjacent elements of the elements 21 to 25. The heat conducting media 33 are disposed at positions so as not to overlap the optical path A (see FIGS. 10A and 10B).

In the optical device 1″ that uses the plate-shaped heat conducting media 33 as described above, heat generated in the element 22, the temperature of which is controlled to increase, is not easily transferred to the other elements 21 and 23 compared to a case in which the above-described cylindrical heat conducting media 32 are used. This is also true with the optical device 2″, in which heat is generated in the element 25 and transferred to the other element 24. However, the difference in the temperatures between the elements housed in the same housing decreases to a similar degree as a case in which the helically structured heat conducting medium 31 is used. The area of the thin film layer 332, which is formed on the heat conducting medium 33, is decreased and the location thereof is limited to part of a region around the optical path A. As a result, efficiency with which organic substances and moisture are gettered decreases compared to a case in which the above-described heat conducting medium 31 or 32 is used. However, compared to the related-art structure in which no heat conducting medium is provided, effects of decreasing the temperature difference between the elements using the heat conducting medium 33 are significant. Thus, an increase in the insertion loss due to adhesion of foreign matter is sufficiently avoidable.

When adjacent elements are physically connected using the plate-shaped heat conducting medium 33, the temperature of a space near an intermediate position between the elements may be relatively decreased compared to the temperature near the elements, and accordingly, there is a possibility of organic substances and moisture being deposited at the space near the intermediate position. However, since the deposited substances adhere and accumulate at positions different from a position on the optical path A of a light beam that propagates between the elements (for example, an upper surface of the base material 20 or an inner surface of the housing 11), the insertion loss is not increased.

Examples of applications related to the above-described optical device 1 will be described below.

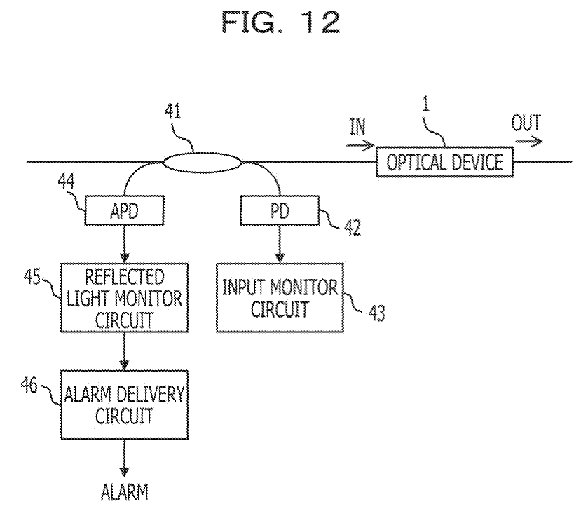

FIG. 12 is a block diagram illustrating the structure of an example of an application to which a function of monitoring the return loss is added in order to monitor adhesion of foreign matter. A return loss refers to the ratio of reflected light to the power of the incident light.

As described above, with the optical device 1, an increase in the insertion loss due to adhesion of foreign matter is reduced and/or avoidable. However, adhesion of foreign matter is a phenomenon that occurs inside the housing and foreign matter is accumulated over the years. With respect to the reliability of the optical device 1, it may be desirable that a function of monitoring reflected light be added to the optical device 1 in order to detect degradation of a reflection loss due to adhesion of foreign matter, and a mechanism that delivers an alarm to an external device when reflected light that exceeds a tolerance is detected be provided.

In the example of the application illustrated in FIG. 12, the power of the reflected light is monitored at an optical input port of the space-coupling optical device 1, adhesion of foreign matter on the optical axis is determined in accordance with a change in monitored value, and delivery of an alarm is performed. Specifically, an optical branch coupler 41 is disposed in the input optical fiber 12 of the optical device 1. The optical branch coupler 41 may use an input optical monitor that is provided in many of typical space-coupling optical devices. The input optical monitor branches part of light to be input to the optical device 1 using the optical branch coupler 41. The branched light is received by a photodiode (PD) 42 and converted into an electrical signal. An input monitor circuit 43 uses the electrical signal in order to detect the level of light input to the optical device 1.

In the optical branch coupler 41, in order to monitor the reflected light power at the optical input port of the optical device 1, an avalanche photodiode (APD) 44 and a reflected light monitor circuit 45 are connected to one of branch ports that is usually unused. The APD 44, which is a photodiode having a self-amplification function, may receive weak reflected light. Although an example here uses the APD in order to receive reflected light, a photo-sensitive element, of which the dark current is small, may be used instead of the APD. The reflected light monitor circuit 45 periodically monitors the power of the reflected light from the optical device 1 in accordance with the level of the electrical signal output from the APD 44, and calculates the amount of variation in the monitored value in order to detect accumulation of adhered foreign matter on the optical axis.

Regarding a processing in the reflected light monitor circuit 45, when foreign matter adheres on a surface of the element positioned on the optical path A inside the housing 11 of the optical device 1, the foreign matter reflects all or part of the light beam. Thus, the power of the reflected light at the optical input port of the optical device 1 is responsive to the adhered foreign matter. The sensitivity of the power of the reflected light for adhesion of foreign matter is higher than the sensitivity of the insertion loss obtained by monitoring input optical power and output optical power of the optical device 1. Thus, by obtaining the amount of variation in the power of the reflected light, the reflected light monitor circuit 45 may detect adhesion of the foreign matter with high precision even when a slight amount of foreign matter is adhered due to use of the optical device 1 over the years.

When a detected result of an increase in the insertion loss exceeds a preset tolerance, the reflected light monitor circuit 45 outputs a signal instructing delivery of an alarm to an alarm delivery circuit 46. By doing this, an alarm that announces occurrence of a problem in the optical device 1 is delivered from the alarm delivery circuit 46 to an external device. Thus, by using the example of the application as described above, a highly reliable space-coupling optical device 1 may be realized.

An embodiment of an optical transceiver using the optical device 1 as described above will be described below.

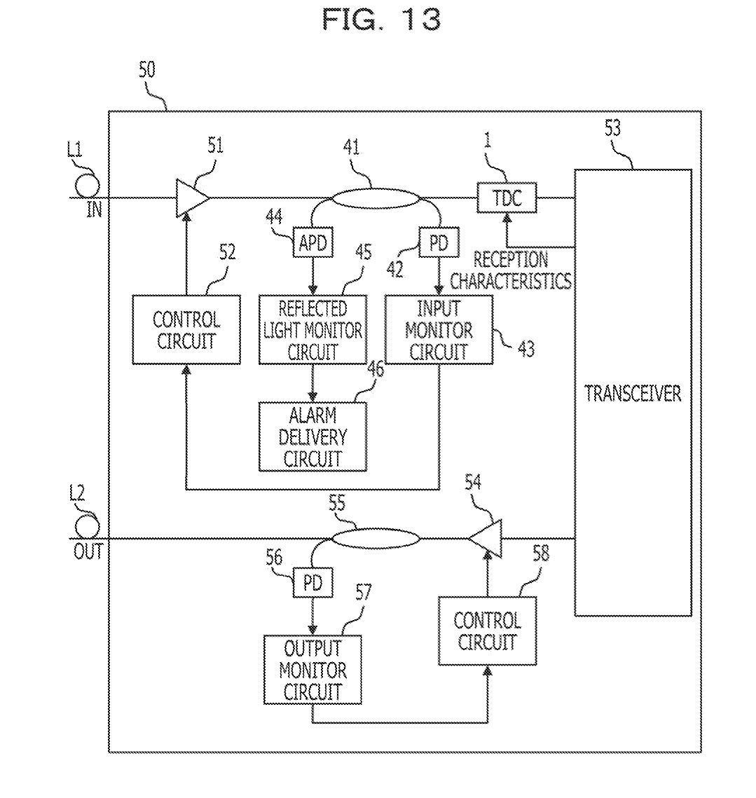

FIG. 13 is a block diagram illustrating the structure of the embodiment of the optical transceiver.

Referring to FIG. 13, an optical transceiver 50, for example, amplifies an optical signal received through an optical transmission line L1 up to a desired level using an optical amplifier 51. After that, the amplified optical signal is input to the optical device 1 having a function of a tunable dispersion compensator (TDC), for example, in order to compensate for chromatic dispersion, and the compensated optical signal is received by a transceiver 53. The optical transceiver 50 amplifies an optical signal generated by the transceiver 53 up to a desired level using an optical amplifier 54, and outputs the amplified optical signal to an optical transmission line L2.

The optical branch coupler 41 illustrated in FIG. 12 above is disposed between the optical amplifier 51 on the receiving side and the optical device 1. The PD 42 and the input monitor circuit 43 are connected to one of the branch ports of the optical branch coupler 41. The APD 44, the reflected light monitor circuit 45, and the alarm delivery circuit 46 are connected to the other branch port. Here, a signal that indicates a monitoring result using the input monitor circuit 43 is transmitted to a control circuit 52 of the optical amplifier 51. The control circuit 52 controls an amplifying operation of the optical amplifier 51 such that the input optical power to the optical device 1 (output optical power from the optical amplifier 51) becomes a desired level. Information on reception characteristics of the optical signal in the transceiver 53 is given to the optical device 1 in order to control the temperature of the element (chromatic dispersion device) such that the amount of chromatic dispersion compensation in the optical device 1 is optimized (e.g., feedback control of characteristics of the wavelength dispersion compensator is performed in accordance with the reception characteristics of the transceiver).

In order to monitor output light power of the optical amplifier 54, an optical branch coupler 55, a photodiode (PD) 56, and an output monitor circuit 57 are provided subsequent to the optical amplifier 54 on the transmitting side. A signal indicating a monitoring result using the output monitor circuit 57 is transmitted to a control circuit 58 of the optical amplifier 54. The control circuit 58 controls an amplifying operation of the optical amplifier 54 such that power of the optical signal transmitted to the optical transmission line L2 becomes a desired level.

In the optical transceiver 50 as described above, even when the optical device 1 is operated for a long time, an increase in the insertion loss due to adhesion of foreign matter does not occur. This allows the transceiver 53 to reliably receive optical signals in a stable manner.

In this example, the optical transceiver uses the optical device that has the function of the TDC. It is clear that the optical transceiver may use an optical device having one of a variety of functions other than TDC disposed at a suitable position.

An embodiment of an optical communication system configured using the optical transceiver 50 as described above will be described below.

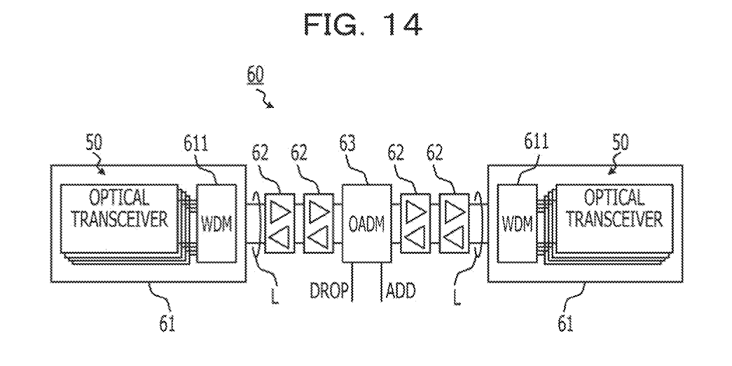

FIG. 14 is a block diagram illustrating the structure of the embodiment of the optical communication system.

Referring to FIG. 14, an optical communication system 60 bidirectionally transmits, for example, wavelength multiplexed light that carries a plurality of optical signals of different wavelengths between two terminal stations 61. A pair of optical transmission lines L connect the terminal stations 61 to each other. On the optical transmission lines L, a plurality of optical relay stations 62 and an optical add/drop multiplexer (OADM) 63 are disposed at desirable intervals.

Each terminal station 61 includes a plurality of optical transceivers 50 and a wavelength division multiplex (WDM) coupler 611. The plurality of optical transceivers 50 transmit and receive optical signals of corresponding wavelengths that are different from each other, and the WDM coupler 611 multiplexes or demultiplexes optical signals that are output from or input to the optical transceivers 50. Each optical relay station 62 amplifies the wavelength multiplexed light, which bidirectionally propagates through the pair of optical transmission lines L, to a desired level and transmits the resultant light. The OADM 63 adds or drops an optical signal of a specified wavelength to the wavelength multiplexed light that is relayed and transmitted through the pair of optical transmission lines L.

With the optical communication system 60 as described above, the optical transceivers 50 that correspond to wavelengths of the terminal stations 61 use the highly reliable optical devices 1 as described above. Thus, bidirectional transmission of the wavelength multiplexed light may be reliably performed in a stable manner.

Although each of the optical transceivers 50 of the terminal stations 61 uses the optical device 1 in the above-described optical communication system 60, components of the optical communication system other than the optical transceivers 50 may use the optical devices according to the present invention so as to realize a variety of functions. The above-described example of the optical communication system includes the terminal stations 61, the optical relay stations 62, and the OADM 63 as the elements. However, the structure of an optical communication system that is configured using the optical device according to the present invention is not limited to the above example.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiments have been described in detail, it should be understood that the various changes, substitutions, and alterations could be made hereto without departing from the spirit and scope of the invention.

What is claimed is:

1. An optical device comprising:
an optical element that is secured to a base material;
a temperature variable element the temperature of which is variable, the temperature variable element being secured to the base material such that light propagates between the temperature variable element and the optical element;
a housing that houses the optical element and the temperature variable element; and
a heat conducting medium that is disposed at a position that is different from a position of the base material and away from an optical path through which the light propagates, the heat conducting medium physically contacting the optical element and the temperature variable element.

2. The optical device according to claim 1,
wherein the housing houses the optical element and the temperature variable element and is air-tight.

3. The optical device according to claim 1,
wherein the heat conducting medium has a heat conductivity that is greater than a heat conductivity of the base material.

4. The optical device according to claim 1, further comprising:
an adhesive that secures the temperature variable element to the base material.

5. The optical device according to claim 1,
wherein the heat conducting medium includes
a gettering portion that absorbs an organic substance and moisture.

6. The optical device according to claim 1,
wherein the heat conducting medium has a helical structure.

7. The optical device according to claim 6,
wherein the heat conducting medium includes
a helical member, and
wherein the gettering portion includes
a thin film layer that is formed on a surface of the helical member, the thin film layer gettering an organic substance and moisture.

8. The optical device according to claim 1,
wherein the heat conducting medium has a cylinder-shaped structure.

9. The optical device according to claim 8,
wherein the heat conducting medium includes
a cylinder-shaped member, and
wherein the gettering portion includes
a thin film layer that is formed at least on an inner surface of the cylinder-shaped member, the thin film layer gettering an organic substance and moisture.

10. The optical device according to claim 1,
wherein the heat conducting medium has a plate-shaped structure.

11. The optical device according to claim 10,
wherein the heat conducting medium includes
a plate-shaped member, and
wherein the gettering portion includes
a thin film layer that is formed on front and rear surfaces of the plate-shaped member, the thin film layer gettering an organic substance and moisture.

12. The optical device according to claim 1,
wherein the temperature variable element is peltier element or heater.

13. The optical device according to claim 1,
wherein the optical element is lens.

14. An optical transceiver comprising:
an optical device,
wherein the optical device includes
an optical element that is secured to a base material,
a temperature variable element the temperature of which is variable, the temperature variable element being secured to the base material such that light propagates between the temperature variable element and the optical element,
a housing that houses the optical element and the temperature variable element, and
a heat conducting medium that is disposed at a position that is different from a position of the base material and away from an optical path through which the light propagates, the heat conducting medium physically contacting the optical element and the temperature variable element.

15. The optical transceiver unit according to claim 14, further comprising:
a monitor portion that detects reflected light of light that is incident upon the optical device.

16. The optical transceiver unit according to claim 15,
wherein the monitor portion periodically monitors power of the reflected light that returns to a light incident end of the optical device and calculates an amount of variation, the monitor portion detecting an increase in an insertion loss due to the optical element and the temperature variable element in accordance with the calculated amount of variation in the power of the reflected light.

17. The optical transceiver unit according to claims 14, further comprising:
an alarm delivery circuit that delivers an alarm when a detected result of the monitor portion exceeds a preset tolerance.

18. The optical transceiver unit according to claims 14,
wherein the optical device has a function of a tunable dispersion compensator that compensates for chromatic dispersion of a received optical signal.

19. An optical communication system comprising:
at least one optical transceiver that includes
an optical device,
wherein the optical device includes
an optical element that is secured to a base material,
a temperature variable element the temperature of which is variable, the temperature variable element being secured to the base material such that light propagates between the temperature variable element and the optical element,
a housing that houses the optical element and the temperature variable element; and
a heat conducting medium that is disposed at a position that is different from a position of the base material and away from an optical path through which the light propagates, the heat conducting medium physically contacting the optical element and the temperature variable element.

20. The optical communication system according to claim 19, further comprising:
a plurality of terminal stations that each transmit and receive wavelength multiplexed light through an optical transmission line,
wherein the at least one optical transceiver comprises a plurality of optical transceivers, wherein the plurality of terminal stations include the respective optical transceivers.
